(19) United States
(12) Patent Application Publication
(10) Pub. No.: US 2020/0160187 A1
(43) Pub. Date: May 21, 2020

(54) IMPROVEMENTS TO ARTIFICIALLY INTELLIGENT AGENTS

(71) Applicant: E & K ESCOTT HOLDINGS PTY LTD, Brisbane, Queensland (AU)

(72) Inventor: Eban Peter ESCOTT, Brisbane, Queensland (AU)

(21) Appl. No.: 16/619,225

(22) PCT Filed: Jun. 8, 2018
(86) PCT No.: PCT/AU2018/050573

§ 371 Date: Dec. 4, 2019

(30) Foreign Application Priority Data
Jun. 9, 2017 (AU) 2017902213

(51) Int. Cl. G06N 3/12; G06F 8/35; G06F 16/901; G06F 8/10

(52) U.S. Cl. CPC G06N 3/126; G06F 8/10; G06F 16/9027; G06F 8/35

(57) ABSTRACT

A method for evolving an artificial intelligence (AI) software agent hosted on an electronic computer, the method comprising: providing an AI agent comprising a mapping assembly responsive to one or more sensors and arranged for control of one or more actuators wherein the mapping assembly includes a model comprising a representation of a target software; providing a conversation tree software procedure executable by the electronic computer; operating the computer to conduct a conversation with a human modeler according to the conversation tree to elicit requirements for the target software; and operating the computer to modify the model based upon information obtained from the conversation with the modeler.

### TECHNICAL FIELD

The present disclosure relates to systems, methods, and apparatus for enabling an artificially intelligent software agent (or “bot”) to communicate with a human for the purpose of enabling the bot to read and update a software model for a model-based software application.

### BACKGROUND

Any references to methods, apparatus or documents of the prior art are not to be taken as constituting any evidence or admission that they formed, or form part of the common general knowledge.

Building computer applications typically involves many stakeholders of varying expertise; such as domain experts, software engineers, user experience designers, business analysts, end users, and project managers. A key challenge of building a successful application is collecting the requirements of the application from the various stakeholders and representing them in a way that is understandable to each stakeholder. Traditionally, software engineers are responsible for translating the requirements into code.

Computer applications are commonly built using software patterns. Software patterns are descriptions or templates for solutions to problems that commonly must be addressed when developing software and which can be used in many different situations. Software written for applications such as mobile applications, web-based systems, embedded systems, and enterprise applications, use software patterns to solve problems and deliver a solution. Traditionally, programming languages like Java, C++, Python and the like are used to write source code for a target application by a software developer. Writing these applications is a time intensive task and carries a high risk of error. The source code is ultimately compiled to executable code which can be read and acted upon by one or more microprocessors of a computer. Under control of the application the microprocessor processes data from sensors such as keyboards, touch screen, mouse, camera and possibly industrial sensors such as temperature and pressure transducers and the like. The microprocessor acts upon the received data from the sensors and operates various actuators in accordance with the application. The various actuators may include one or more display screens but also almost any other kind of machine controllable actuator, such as solenoids for example.

The Human software engineers can accomplish these tasks, though much of what they do may be considered infrastructure in that it involves reusing prebuilt code. More recently, it has been known for software to be designed and built using computer implemented modelling environments whereby some of the source code for a target application can be automatically generated.

Model-based applications can be used to represent a software system either graphically, textually or with a hybrid approach. The models can be used to generate large portions of the software system that leads to many tangible benefits.

Computer software can be created updated and read using model based representations. Unlike traditional source code, the model is a high-level representation of the source code. Code generators, i.e. specially programmed software executed on computers, can be used to write code for target software from the model, instead of the code being written by a human. The models can be graphical, textual or a hybrid but they must allow the modeller to express the requirements that the resultant target software application is required to meet. Graphical models, presented by way of a graphical user interface on a display screen of a computer, usually allow shapes to be rendered, moved and connected, with other elements to represent the software. Textual models like Domain-Specific Languages (DSLs) can look like natural language and are ideal for some problem scenarios. A hybrid approach uses both graphical and textual notations. A table or spreadsheet could be considered a hybrid approach and used as a model of the software application and a way for the modeller to express the intent of their desired target software.

Model-Driven Engineering (MDE) is an advanced approach to software engineering that uses models in the software development life cycle. As an example, FIG. 1 is a diagram showing a meta-model 10, model 12, XML representation of the model 14, code generator 16 and output application code 18. An example of the output of an example application code 18 is shown in box 119.

In the meta-model 10 elements and associations between elements are defined. In the model layer a model is stored that, in this example, includes two entities, each being an instance of an element that is defined in the metamodel layer 10. The two entities of the model 12 are related by a relationship that is an instance of an association defined in the meta-model 10. The model 12 can be represented in a number of ways, for example it can be represented graphically as shown in FIG. 1 or textually. The XML document 14 captures all of the instances of elements and associations of the model. The XML document 14 can be applied to a software application known as a code generator 16. The output from the code generator 16 comprises a target software application 18 for execution by a computer. Consequently, it will be understood that modification of the model 12 and in some circumstances also of the meta-model 10 will result in modification of the target software application 18. Conversely, for a given software application it is possible to define a corresponding model and also a corresponding meta-model.

It will therefore be realised that a model, such as model 12 of FIG. 1, is a high level representation of a software application. The model can undergo model-to-model (M2M) and model-to-text (M2T) transformations that results in some—not necessarily all—of the source code of the target application being automatically generated. Some examples of well-known modelling environments include the Unified Modelling Language (UML), Business Process Modelling Notation (BPMN), and Business Process Execution Language (BPEL).

The meta-model 10 defines what can be found in the model 12. For example, if the meta-model has an element such as a class called Entity, then the modeller can add as many instances of the Entity to the model as required and label them accordingly.

A well-known example is the Meta-Object Facility (MOF) in which four layers are defined as follows; real world, model, meta-model and meta-meta-model. Each layer defines what is allowed in the layer above but there is no mandate to use MOF or restriction on the number of layers that may be used.

The process of reading and editing models in an intuitive way is the subject of ongoing research. Traditional computer implemented model-based environments provide the modeller with a set of tools so that he or she can use shapes, lines, text, colours, shades, and other visual elements to manipulate the model.

Artificial Intelligence (AI) is the study of intelligence in computing machines. In general, an agent (or “bot”) is a software agent (or more concisely simply an “AI agent”) which receives information about its environment from sensors and is able to control actuators that act upon the environment. FIG. 2 depicts a simple bot 190 that has been built according to a very basic AI architecture which is referred to as a “reactive architecture”. Bot architectures, like software architectures, are formally a description of the elements from which a system is built and the manner in which they communicate. Furthermore, these elements can be defined from patterns with specific constraints. In the reactive architecture of FIG. 2, bot 190 exhibits behaviour that is simply a mapping between stimulus and response. The bot 190 has no decision-making skills. Sensors 202 are provided for the bot to observe the environment 201 and actuators 203 for the bot to act on the environment 201. The input 205 and output 206 data is represented using a semi-structured format such as JSON or XML. The mapping engine 204 matches the input data to the output data. A known example of this architecture is Alicebot, which is based on the Artificial Intelligence Markup Language (AIML). The use of categories, patterns, templates, and the principle of reductionism can result in an AI that scores highly on the Turing test.

A more complex AI architecture is the Procedural Reasoning System (PRS) Architecture. An example of a bot 195 according to the PRS Architecture is illustrated in FIG. 3. The PRS is a general purpose architecture that is ideal for reasoning environments where actions can be defined by predetermined procedures (action sequences). PRS is a Belief-Desire-Intention (BDI) architecture mimicking a theory of human reasoning.

PRS Architecture integrates both reactive and goal-directed deliberative processing in an architecture that has a clear separation of concerns. The belief 210 represents the bots view of the world, desires are the goals 212 the bot uses as a heuristic, the plans 213 are actions that the bots can take, and the intentions 214 specify one or more actions. The interpreter 211 is responsible for controlling the bot. PRS is a useful architecture when planning is more about selection than search or generation.

To build a bot a software development process, which the present Inventor has previously co-conceived, is followed as depicted in FIG. 4. At the start of the iteration 100 a set of requirements are prioritised from the product backlog and these are implemented in the first iteration. At 102 it is determined if the bot is able to implement the requirements without the help of a human. If the bot cannot implement the requirement in a satisfactory way, then a human software developer will begin the process of expanding out what requirements the bot can implement. This is achieved by the human writing the source code that fulfils the requirement (using traditional software development) and this is called the reference implementation 104.

Creating the reference implementation 104 is an important step, as the reference implementation represents how the bot will write source code so it will be human readable and considered best practice as it was originally implemented by a human expert. The next steps 105 and 106, which are implemented by the human modeller are where the reference implementation is abstracted to the transformations, meta-model and model. At this point the meta-model is expanded for two purposes; firstly, the meta-model definition may need to support new elements in the model. Secondly, the meta-model definition is marked to support dialogue data and communication for a chat interface of the bot. Once the reference implementation and the generated application are comparable (107, 108, and 109), the modeller is able to complete the requirement by updating the model 111, generating the application 114, checking the outcome 116 and ending the iteration 118.

By following the build process in FIG. 4 the human and bot cooperate to iteratively evolve the bot so that the bot can comply with more and more requirements. As the bot becomes more advanced, some requirements will not require changes to the bot as the bot will be able to implement the requirements as depicted in FIG. 5. However, there are some requirements that are too complex, or a one off, and changes to the bot are not warranted. So, as depicted in FIG. 6, a decision is made at 121 that a manual update from a human software developer 123 is warranted. Since the bot has written code that is human readable, this is achievable by the software developer manually adding code to the target application.

Whether or not it is possible to improve the bot's intelligence in a specific domain largely depends on the extent to which the bot is able to understand the model and communicate with the human modeller.

The process of reading and editing models in an intuitive way is the subject of ongoing research. Traditional model-based environments provide the human modeller with a set of tools where they can use shapes, lines, text, colours, shades, and other visual elements to manipulate the model. While these approaches provide the modeller with a set of fine grained tools to manipulate the model it would be advantageous if the burden on the human modeller could be reduced further.

### SUMMARY OF THE INVENTION

According to a first aspect of the present invention there is provided a method for evolving an artificial intelligence (AI) software agent hosted on an electronic computer, the method comprising:

providing an AI agent comprising a mapping assembly (which may be referred to as an “intermediate assembly” or an “interpreter assembly”) responsive to one or more sensors and arranged for control of one or more actuators wherein the mapping assembly includes a model comprising a representation of a target software;
operating the computer to conduct a conversation with a human modeler according to a conversation tree to elicit requirements for the target software; and
modifying the model based upon information obtained from the conversation with the modeler.

In a preferred embodiment of the invention the step of providing the mapping assembly includes providing said assembly including a meta-model in association with the model.

It is preferred that the step of providing the mapping assembly further includes providing said assembly with a map such as a corpus database disposed between the meta model and the model.

Preferably the method further includes providing the AI software agent with a code generator assembly whereby the model is applied to the code generator assembly to produce the target software.

It is preferable that the method includes testing the target software for compliance with current requirements of the modeler and, in the event of the target software being non-compliant, iteratively further operating the electronic computer to conduct the conversation with the human modeler and further modifying the model based upon information obtained from the conversation to thereby create a further iteration of the AI agent.

In a preferred embodiment of the invention the method further includes storing a dialog forest in association with the AI agent, the dialog forest representing past conversations to assist the AI agent to determine a plan based on prior successful conversations.

According to a further embodiment of the present invention there is provided a computer programmed with instructions comprising an artificial intelligence (AI) software agent hosted upon the computer, the AI agent comprising:

a mapping assembly responsive to one or more sensors and arranged for control of one or more actuators wherein the mapping assembly includes a model comprising a representation of a target software; and
a conversation tree accessible to the mapping assembly for enabling the computer to conduct a conversation with a human modeler;
wherein the mapping assembly is responsive to the conversation tree and is arranged to modify the model based upon information obtained from the conversation with the human modeler.

Preferably the instructions further comprise a code generator module arranged to generate the target software based upon the model.

### BRIEF DESCRIPTION OF THE DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description will make reference to a number of drawings as follows:

FIG. 1 is a diagram illustrating an exemplary meta-model, model and target software application.

FIG. 2 depicts a bot according to a prior art reactive architecture where the behaviours are simply a mapping between stimulus and response. The bot has no decision-making skills.

FIG. 3 depicts a bot according to a Procedural Reasoning System (PRS) architecture where the bot follows a theory of human reasoning. Belief represents the view of the world, Desires are the goals, and Intentions specify the use of belief and desires to choose one or more actions.

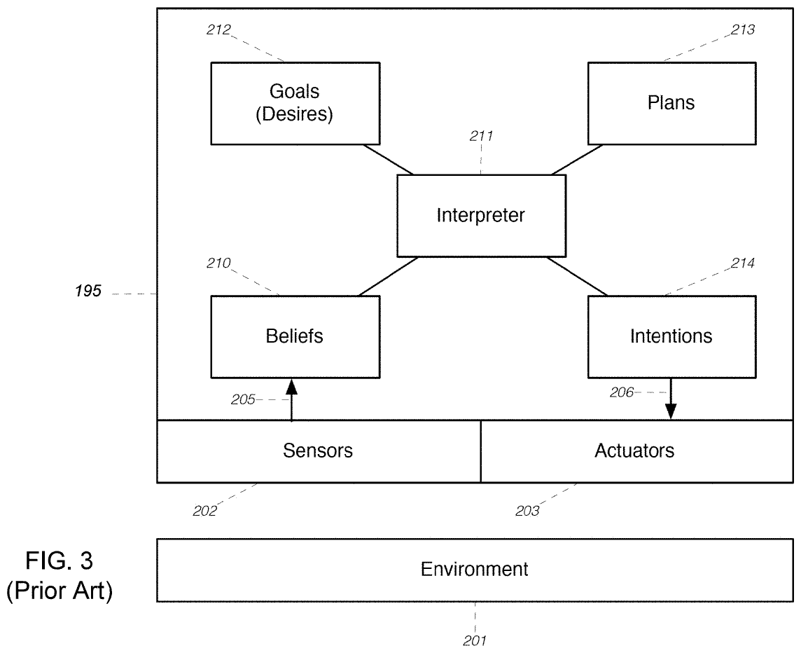

FIG. 4 is a flowchart depicting a build process of a bot. The process illustrated in the figure is evolutionary as the bot is improved each iteration as new requirements are considered.

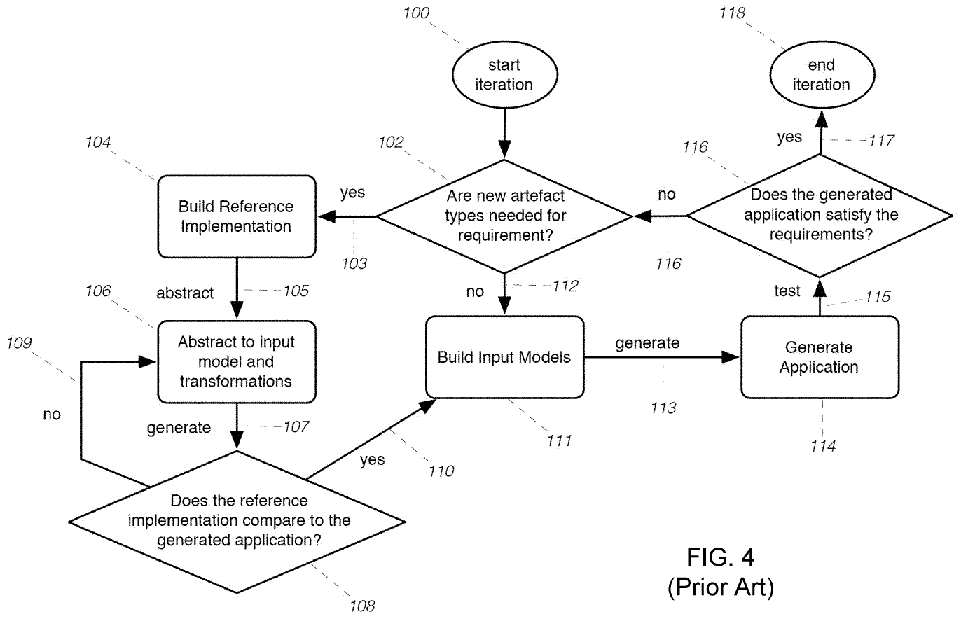

FIG. 5 is a flowchart depicting a build process when no improvements to the bot are needed to satisfy the requirements.

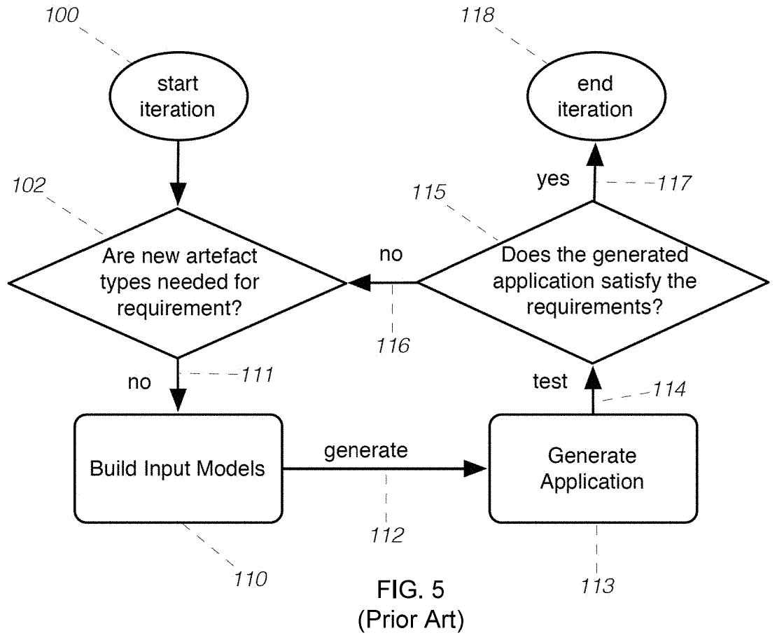

FIG. 6 is a flowchart depicting a build process when manual intervention by a software engineer is preferable over improving the bot.

FIG. 7A depicts a computer system according to a preferred embodiment of the present invention.

FIG. 7B depicts a bot according to a first embodiment of the present invention according to a reactive architecture with a model, meta-model and corpus database providing mapping between stimulus and response.

FIG. 8 depicts a bot according to a PRS architecture with a model, metamodel and corpus database providing the interpreter with a framework for the bots beliefs, goals, plans, and intentions.

FIG. 9 is a conceptual chat interface for the bot on a mobile-app device.

FIG. 10 is a conceptual chat interface for the bot on a tablet device.

FIG. 11 is a conceptual chat interface for the bot on a desktop computer.

FIG. 12 is a high-level conversation tree according to a preferred method of the present invention and demonstrates how the answer from one question leads to the next question in the tree.

FIG. 13 is a detail of an example of a conversation tree wherein the bot asks a human modeller questions about the software application.

FIG. 14 is an architectural diagram of an operational environment to show how an end user interacts with a bot and source code repository in a cloud-based environment.

### DETAILED DESCRIPTION OF PREFERRED EMBODIMENTS

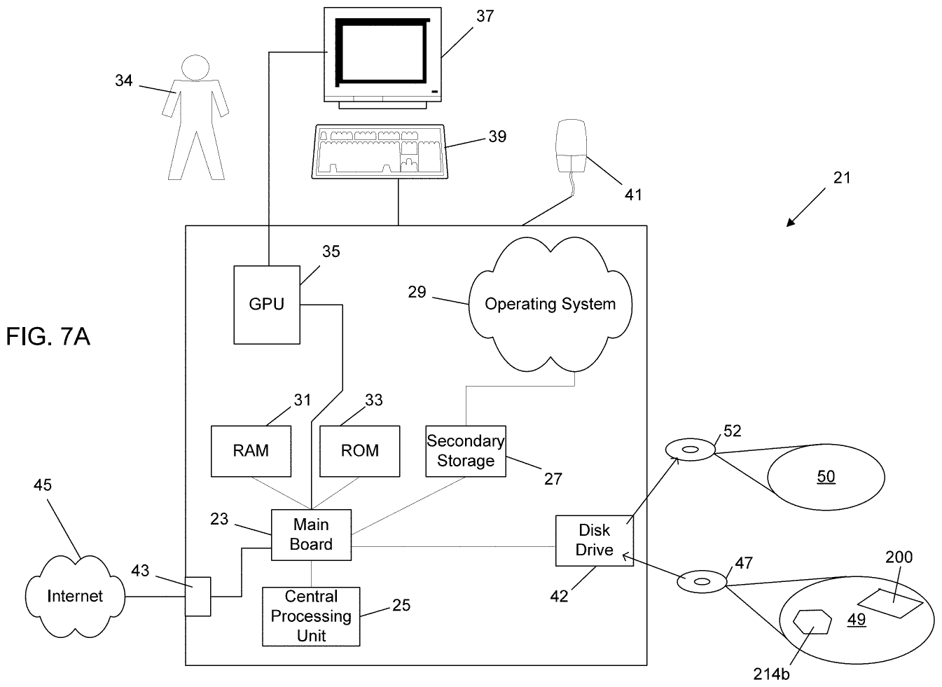

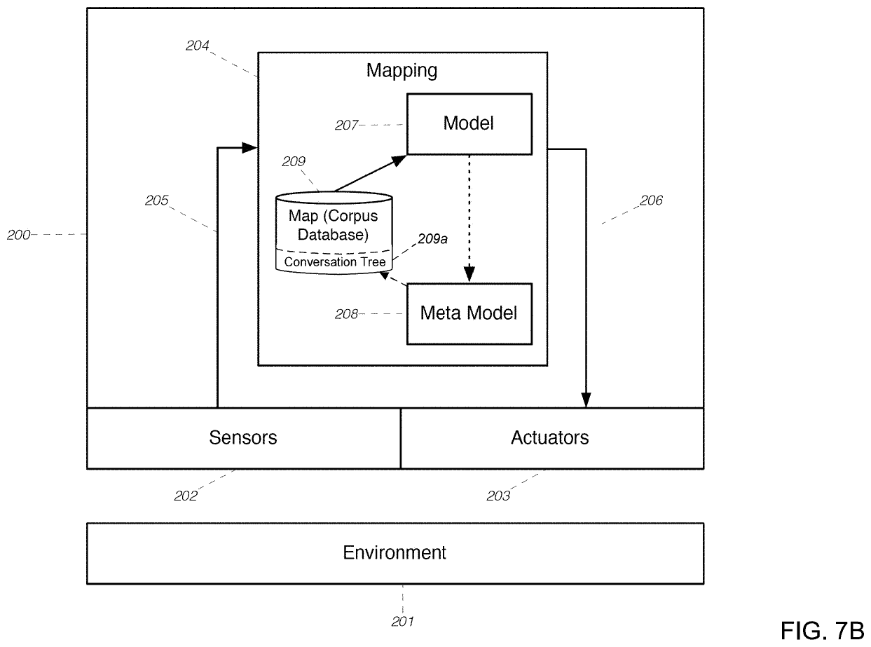

FIG. 7A is a block diagram of an exemplary computer system 21 for carrying out a method according to an embodiment of the invention that will be described.

The computer system 21 includes a main board 23 which includes circuitry for powering and interfacing to at least one onboard Central Processing Unit (CPU) 25. The at least one onboard processor 25 may comprise two or more discrete processors or processors with multiple processing cores.

The main board 23 acts as an interface between CPU 25 and secondary memory storage 27. The secondary memory 27 may comprise one or more optical or magnetic, or solid state, drives. The secondary memory 27 stores instructions for an operating system 29. The main board 3 includes busses by which the CPU is able to communicate with random access memory (RAM) 31, read only memory (ROM) 33 and various peripheral circuits. The ROM 33 typically stores instructions for a Basic Input Output System (BIOS) which the CPU 25 accesses upon start up and which preps the CPU 25 for loading of the operating system 29.

The main board 23 also interfaces with a graphics processor unit (GPU) 35. It will be understood that in some systems the graphics processor unit 35 is integrated into the main board 23. The GPU 15 drives a display 37 which includes a rectangular screen comprising an array of pixels.

The main board 23 will typically include a communications adapter, for example a LAN adaptor or a modem, either wired or wireless, that is able to put the computer system 21 in data communication with a computer network such as the Internet 45 via port 43.

A user 34 of the computer system 21 interfaces with it by means of keyboard 39, mouse 41 and the display 37.

The user 34 of system 21 may command the operating system 29 to load software product 49 which contains instructions comprising an artificial intelligence (AI) software agent 200 for hosting upon the computer system 21. The software product 49 may be provided as tangible instructions borne upon a computer readable media such as optical disk 47 for reading by disk reader/writer 42. Alternatively it might also be downloaded via port 43 from a remote data source via data network 45.

As will be discussed, the AI software agent 200 includes a mapping assembly responsive to one or more sensors and arranged for control of one or more actuators. The mapping assembly includes a model comprising a representation of a target software and a conversation tree accessible to the mapping assembly for enabling the computer system 21 to conduct a conversation with a human modeller, e.g. user 34 using the interface provided by screen 37, keyboard 39 and mouse 41. As will be further explained, in use the mapping assembly is responsive to the conversation tree and is arranged to modify the model based upon information obtained from the conversation with the modeller 34.

The software product 49 also includes machine readable instructions comprising a code generator assembly 214b to produce the target software 50. For example the target software 50 may be output as one or more files comprising tangible machine readable instructions on a magnetic or optical disk 52 or alternatively it may be transmitted in the form of machine readble files to a remote location via port 43 and data network 45.

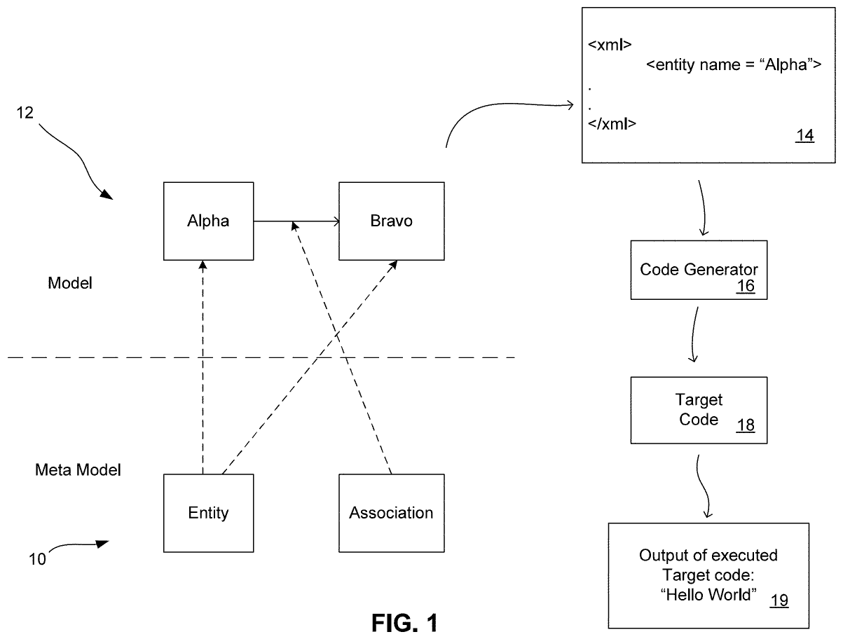

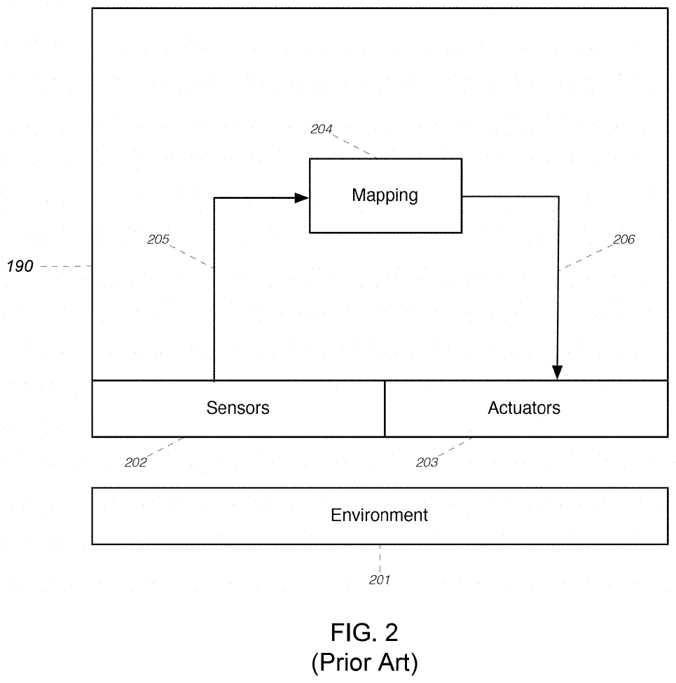

The bot 200 of FIG. 7A is illustrated in FIG. 7B. Bot 200 is constructed according to an extension of the reactive architecture of the bot of FIG. 2. With reference to FIG. 7B, a mapping engine 204 is provided that is composed of a model 207, meta-model 208 and a corpus database 209. In the presently described embodiment of the invention the corpus database 209 stores a conversation tree 209a that enables the bot 200 to converse with a human. The corpus database 209 also records conversations that the bot 200 has with a human by means of the conversation tree. The model 207 is the representation of a target software application (e.g. application 18 of FIG. 1). It can be graphical, textual or a hybrid model. The meta-model 208 defines the elements that can be added to the model. Furthermore, the meta-model is used to define the corpus database that contains the input 205 and output 206 data. As will be discussed, by utilising the meta-model 208 a domain specific language (DSL) can be formed that allows communication between the human 34 and the bot 200 with a shared understanding of the model 207.

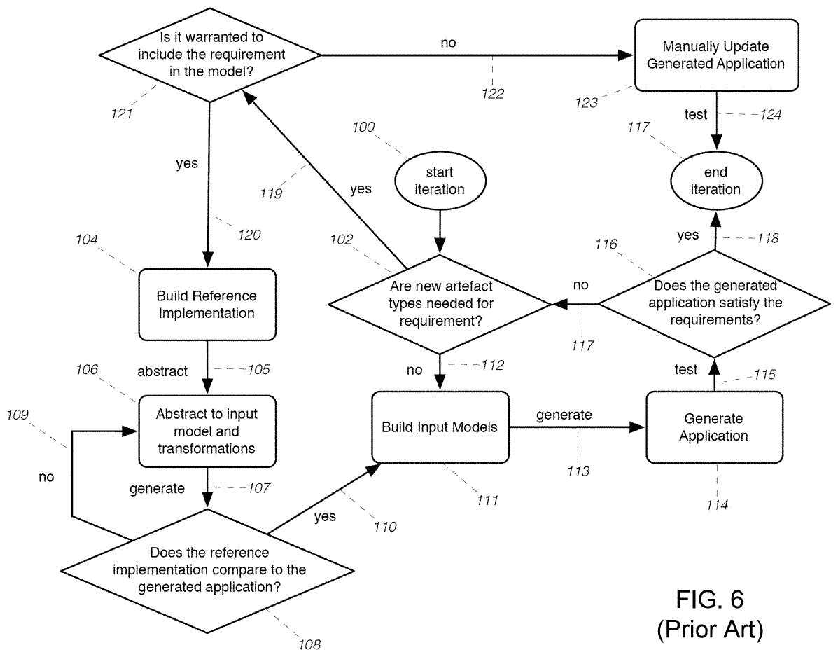

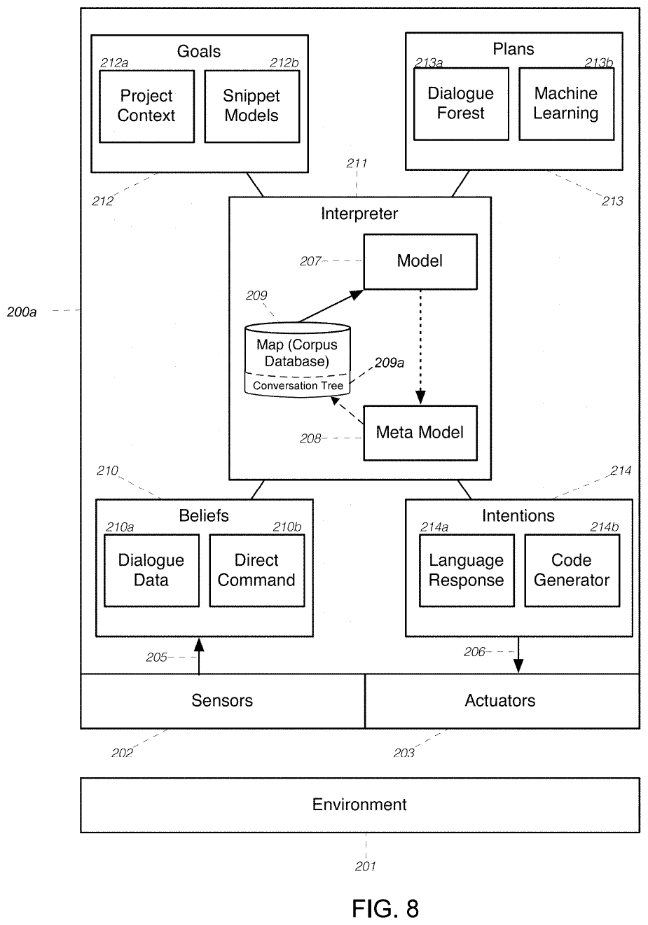

A bot 200a according to further embodiment of the present invention is depicted in FIG. 8. The bot 200a of FIG. 8 is configured according to a model-based extension to the PRS architecture of FIG. 6. The Beliefs are represented by dialogue data 210a that is received from the end user. Direct commands 210b can be invoked depending on where the user currently is in the conversation tree 209. The conversation tree 209a is a data structure that is stored in the corpus database 209. The interpreter 211 comprises a mapping assembly that has a similar internal structure to the mapping assembly 204 of the bot 200 according to the embodiment of FIG. 7B.

However the interpreter 211 of FIG. 8 uses algorithms based on the goals 212a and plans 212b to determine the intentions 214. The project context 212a uses categories, patterns, templates, and the principle of reductionism (similar to AIML) to simplify a range of natural language inputs and keep context for personalised responses. The snippet models 212b are linked to Epics and User Stories so that the interpreter 211 can make large changes to the model 207 by either copying the snippets or making comparisons between its own model and the snippet.

Epics and User Stories are employed to capture requirements in an Agile software development process. An Epic captures a large body of work and is a broad requirement. An example format of an Epic is: As a [type of user] I want to [do something] so that [reason for task] A User Story is a specific requirement and are grouped into Epics, i.e. an Epic has many User Stories. An example format of a User Story is: As a [type of user] like [persona] at [environment]. I want to [do something] using [device] so that [reason for task]. This will [user goal].

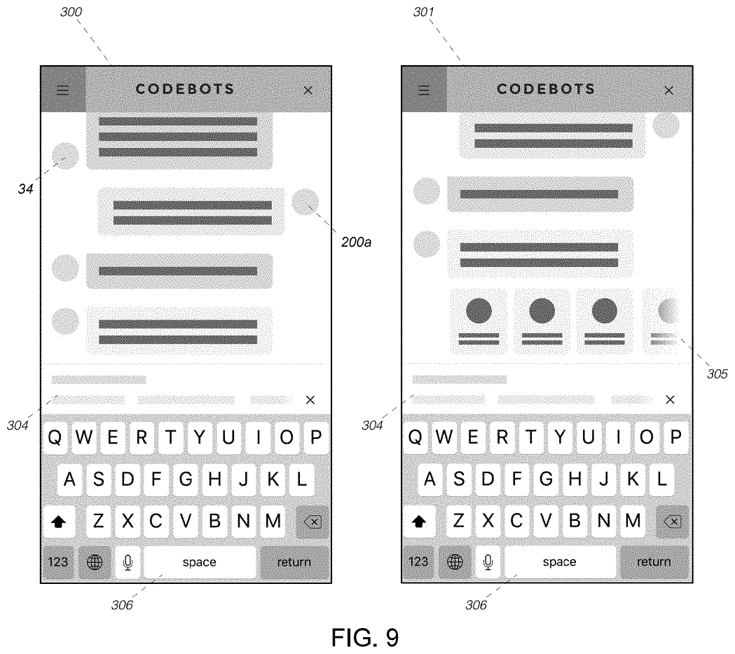

For the bot to be intelligent in a specific domain, i.e. the domain for the target software, the bot must be able to understand the model 207 and communicate with the modeller 34. According to a preferred embodiment of the present invention, the bot's understanding of the model 207 is achieved by extending the Reactive and PRS architectures to arrive at the model based bot embodiments 200, 200a shown in FIGS. 7B and 8. The communication with the modeller 34 (a human) is preferably achieved using a chat interface, i.e. screens as depicted in FIGS. 9 through 11 that are displayed on the screen 37 of a machine, e.g. computer system 21, hosting the bot. In the presently described embodiment the bot's conversation tree is based on the model 207 and its meta-model 208.

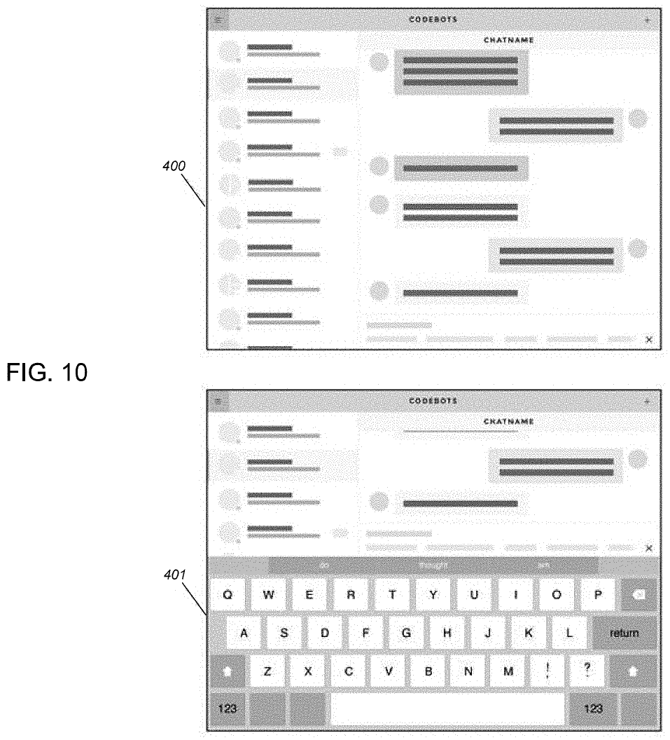

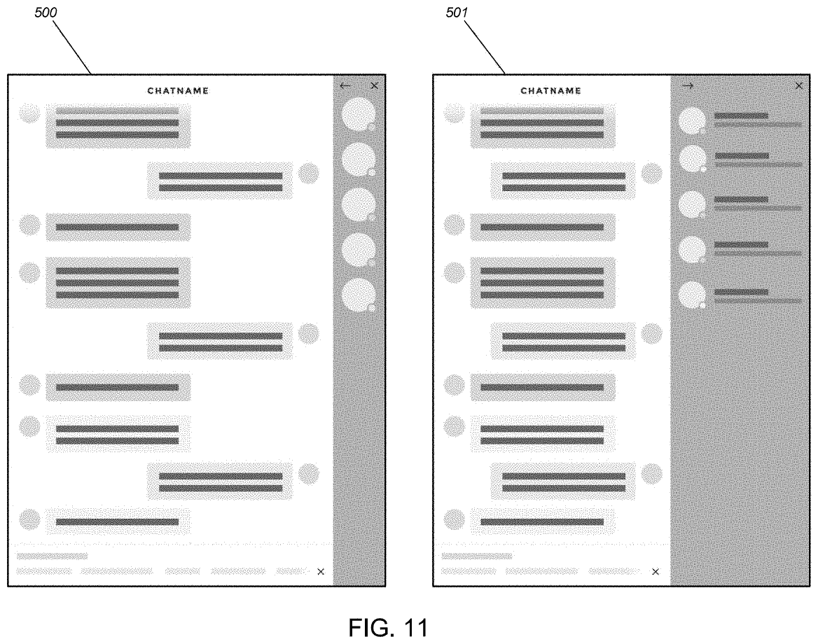

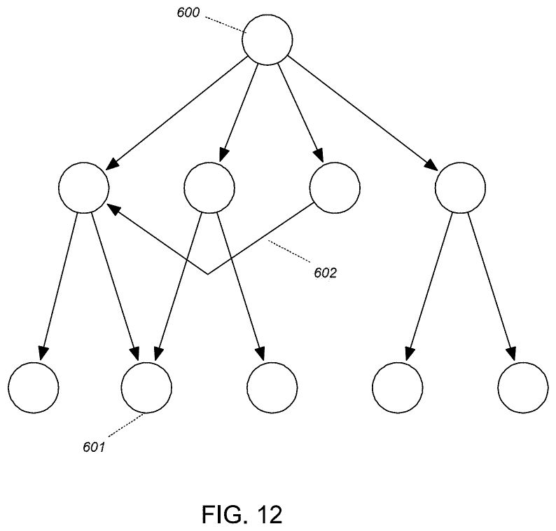

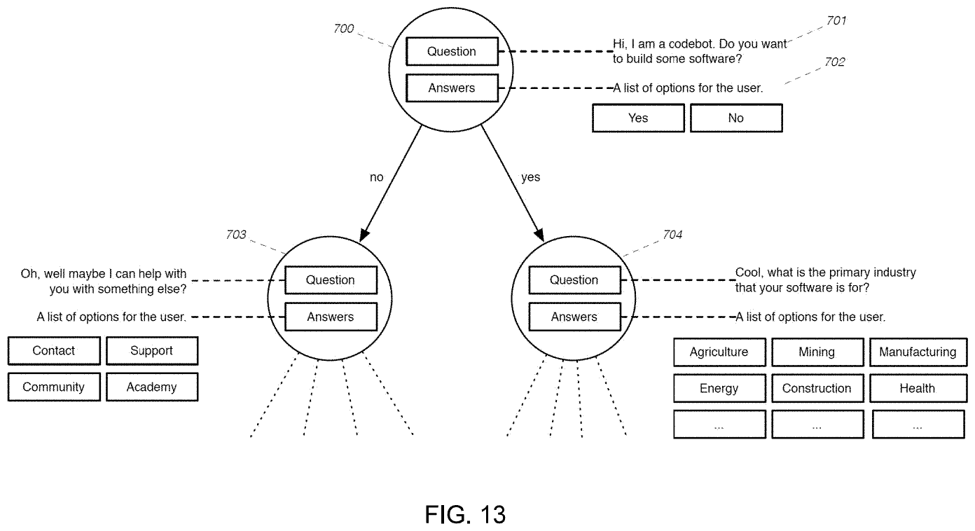

The chat interface can be adapted for different devices like the mobile-app (300 and 301) depicted in FIG. 9, tablet (400 and 401) depicted in FIG. 10, and the desktop (500 and 501) depicted in FIG. 11. FIG. 12 is a high level diagram of a conversation tree whereas FIG. 13 drills down to show parts of the tree of FIG. 11 in detail. FIG. 12 depicts an exemplary conversation tree at a high-level and demonstrates how the answer from one question (e.g. node 600) leads (via link 602) to the next question in the tree and ultimately to a final question 601. The human 34 and bot 200 communicate using a structured DSL (domain specific language) based on the conversation tree 209a. The human is presented with options (304 and 305) to direct the bot to carry out tasks on the model e.g. model 207 of FIG. 7B and FIG. 8. Some of the advanced tasks will save significant time compared to traditional model-based environments where the human is required to make many changes across the model to achieve an intended outcome.

Referring again to FIG. 8, the dialog forest 213a represents all the conversations that the bot has with the end users so that it can double check based on previous questions. This coupled with a machine learning algorithm 213b allows the bot to determine a plan based on previous successful conversations. The language response 214a is the selection from the conversation tree made by the interpreter. The code generator 214b is invoked for the bot to write target software 50. The code generator 214b uses the model 207 as the basis for what it writes. So, as the interpreter makes changes to the model from the beliefs 210, goals 212, and the plans 213, the bot will be able write the code for the target software that is up to date with the current conversation with the end user 34.

Consequently due to interaction with the human modeler the model can be updated so that the bot evolves and is able to comply with more and more requirements.

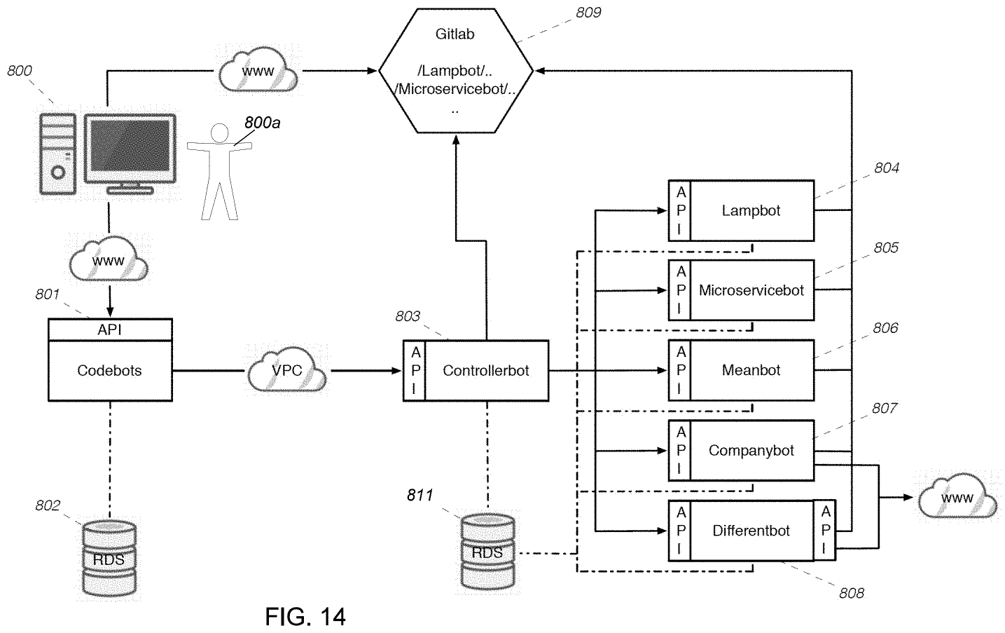

The enhanced Reactive and PRS architecture embodiments of FIGS. 7B and 8, according to embodiments of the invention, can be used to implement different bots. The bots must subsequently be deployed into an environment and bought online for the end user. A deployment system is illustrated in FIG. 14.

With reference to FIG. 14, the end user (identified as item 800a in FIG. 14) will use the chat interface on their machine 800. The conversation will be submitted to a typical web application (801 and 802) and the application will delegate the conversation to one of bots 804-808 depending on the nature of the technology stack (e.g. hardware/operating system platform) that the target software is to run on. For example, if the target software is intended to run on a Linux Apache MySQL PHP platform then the LAMP bot will be selected, via a Controllerbot 803. The particular delegated bot 804-808 will write code and commit it to the source repository 809. To further allow the human and bot to work alongside each other, the end user 800a, via machine 800, can also have access to the source repository 809. In the system of FIG. 14 the relational database service (RDS) 811 stores data for use by the controllerbot 803 and each of the bots 804-808. In particular, conversation trees and dialogue forests may be stored in the RDS and be accessible to each of the bots 804-808.

Implementations of the invention can be realized as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter affecting a machinereadable propagated signal, or a combination of one or more of them. The term “computer system” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this disclosure can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, implementations of the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations of the present disclosure can be realized in a computing system that includes a back end component, e.g., as a data server, or that includes a middleware component, e.g., an application server, or that includes a front end component, e.g., a client computer having a graphical user interface or a Web browser through which a user can interact with an implementation of the present disclosure, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this disclosure contains many specifics, these should not be construed as limitations on the scope of the disclosure or of what may be claimed, but rather as descriptions of features specific to particular implementations of the disclosure. Certain features that are described in this disclosure in the context of separate implementations can also be provided in combination in a single implementation. Conversely, various features that are described in the context of a single implementation can also be provided in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the present disclosure have been described. Other implementations are within the scope of the following claims. For example, the actions recited in the claims can be performed in a different order and still achieve desirable results.

In compliance with the statute, the invention has been described in language more or less specific to structural or methodical features. The term “comprises” and its variations, such as “comprising” and “comprised of” is used throughout in an inclusive sense and not to the exclusion of any additional features. It is to be understood that the invention is not limited to specific features shown or described since the means herein described comprises preferred forms of putting the invention into effect.

The invention is, therefore, claimed in any of its forms or modifications within the proper scope of the appended claims appropriately interpreted by those skilled in the art.

Throughout the specification and claims (if present), unless the context requires otherwise, the term “substantially” or “about” will be understood to not be limited to the value for the range qualified by the terms.

Any embodiment of the invention is meant to be illustrative only and is not meant to be limiting to the invention. Therefore, it should be appreciated that various other changes and modifications can be made to any embodiment described without departing from the spirit and scope of the invention.

1-10. (canceled)

11. A method for evolving an artificial intelligence (AI) software agent hosted on an electronic computer, the method comprising:
providing an AI agent comprising a mapping assembly responsive to one or more sensors and arranged for control of one or more actuators wherein the mapping assembly includes:
a model comprising a representation of a target software;
a meta-model in association with the model; and
a corpus database responsive to the meta-model and accessible by the model;
said corpus database providing a conversation tree software procedure executable by the electronic computer, the conversation tree based upon the model and the meta-model;
operating the computer to conduct a conversation with a human modeler according to the conversation tree to elicit requirements for the target software; and
operating the computer to modify the model based upon information obtained from the conversation with the modeler.

12. The method according to claim 11, including applying the model to a code generator assembly to produce the target software.

13. The method according to claim 12, including testing the target software for compliance with current requirements of the modeler and, in the event of the target software being non-compliant, iteratively further operating the electronic computer to conduct the conversation with the human modeler and further modifying the model based upon information obtained from the conversation to thereby create a further iteration of the AI agent.

14. The method according to claim 11, including storing a dialog forest in association with the AI agent, the dialog forest representing past conversations to assist the AI agent to determine a plan based on prior successful conversations.

15. A computer programmed with instructions comprising an artificial intelligence (AI) software agent hosted upon the computer, the AI agent comprising:
a mapping assembly responsive to one or more sensors and arranged for control of one or more actuators wherein the mapping assembly includes:
a model comprising a representation of a target software;
a meta-model in association with the model; and
a corpus database responsive to the meta-model and accessible by the model; and
said corpus database providing a conversation tree based upon the model and the meta-model for enabling the computer to conduct a conversation with a human modeler;
wherein the mapping assembly is responsive to the conversation tree and is arranged to modify the model based upon information obtained from the conversation with the human modeler.

16. The computer programmed with instructions comprising an artificial intelligence (AI) software agent hosted upon the computer, according to claim 15 wherein the instructions further comprise a code generator module arranged to generate the target software based upon the model.
